(19) United States
(12) Patent Application Publication
(10) Pub. No.: US 2017/0365880 A1
(43) Pub. Date: Dec. 21, 2017

(54) SECONDARY BATTERY

(71) Applicant: CONTEMPORARY AMPEREX TECHNOLOGY CO., LIMITED, Ningde City (CN)

(72) Inventors: Wujun ZOU, Ningde City (CN); Xiaowen ZHANG, Ningde City (CN); Haizu JIN, Ningde City (CN); Jian DUAN, Ningde City (CN); Weitao WANG, Ningde City (CN); Xing LI, Ningde City (CN)

(21) Appl. No.: 15/627,845

(22) Filed: Jun. 20, 2017

(30) Foreign Application Priority Data
Jun. 20, 2016 (CN) 201610447535.2

(51) Int. Cl. H01M 10/0567; H01M 2/04; H01M 10/0525; H01M 10/44

(52) U.S. Cl. CPC H01M 10/0567; H01M 10/445; H01M 2/0486; H01M 10/0525; H01M 10/443

(57) ABSTRACT

The secondary battery of the present application includes a cell, an electrolyte and a case, the cell includes electrodes and a separator. The secondary battery further includes a gas-generating additive and a water-generating additive. During the overcharging process of the Li-ion battery, when the battery reaches a certain temperature, the water-generating additive decomposes and generates a large amount of water. Then, Li salt and the gas-generating additive are induced to decompose and generate a large amount of gas, so that when the internal pressure of the battery reaches a certain value, the charging current is interrupted in advance by a device for interrupting charging current. Moreover, the water-generating additive can absorb the heat generated by the battery during decomposition, so that the internal temperature of the battery decreases, thereby preventing the overcharge failure of the battery.

### CROSS-REFERENCE TO RELATED APPLICATIONS

The present application claims the benefit of priority to Chinese Patent Application No. 201610447535.2, filed on Jun. 20, 2016, the content of which is incorporated herein by reference in its entirety.

### TECHNICAL FIELD

The present application relates to the field of energy storage technologies and, more particularly, to a secondary battery.

### BACKGROUND

Since new energy vehicle comes into public life, the new energy vehicle, in which a Li-ion battery is mainly used as the power battery, is facing test and challenge on safety performance. Generally speaking, a main safety problem of a traditional vehicle occurs when the vehicle is in dynamic motion, such as battery burning caused by severe collision accident. However, in static state, the electric vehicle may suffer thermal runaway, self-ignition, or burning caused by overcharge, short circuit, or liquid leakage of the battery since the battery management system is imperfect. Those safety problems occur most frequently in the charging process. To prevent overcharge in cell level can improve safety performance of the new energy vehicle.

Since flammable and explosive electrolyte is used in the Li-ion battery, when the battery has been fully charged, if the battery management system cannot interrupt the current in time, the battery will be still charged by external power supply, and thus may be overcharged. When the battery is overcharged, since the voltage and current are too high, the electrolyte may be oxidized, thereby generating a large amount of gas, and then the temperature of the battery rapidly increases due to heat generated by chemical reaction in the interior of the battery, and finally, the battery will suffer thermal runaway, which results in burning.

In order to prevent overcharge of the battery, the present application is proposed.

### SUMMARY

A purpose of the present application is to provide a secondary battery.

In order to achieve the purpose of the present application, adopted technical solutions are as follows:

A secondary battery, including a cell, an electrolyte and a case, the cell includes electrodes and a separator; the secondary battery further includes a gas-generating additive and a water-generating additive.

Preferably, the secondary battery further includes a device for interrupting charging current, the device is preferably a current interrupt device or a safety short device.

Preferably, the gas-generating additive includes at least one of a group consisting of compounds capable of decomposing under high voltage, preferably, the gas-generating additive is lithium carbonate.

Preferably, the water-generating additive includes at least one of a group consisting of inorganic compounds or organic compounds capable of decomposing and generating water when being heated; preferably, the inorganic compound is selected from a group consisting of hydroxide, acidic salt, basic salt, hydrate and combinations thereof; the hydroxide is preferably selected from a group consisting of zinc hydroxide, aluminum hydroxide, magnesium hydroxide, copper hydroxide and combinations thereof; the acidic salt is preferably selected from a group consisting of ammonium oxalate, sodium bicarbonate and combinations thereof; the basic salt is preferably selected from a group consisting of basic cupric carbonate, basic magnesium carbonate and combinations thereof; the hydrate is preferably selected from a group consisting of manganese acetate tetrahydrate, aluminium chloride hexahydrate, copper sulfate pentahydrate, aluminum potassium sulfate dodecahydrate and combinations thereof; and the organic compound is a compound containing at least one carboxyl, preferably, the organic compound is oxalic acid.

Preferably, a decomposing temperature of the water-generating additive is between 60° C.-150° C.

Preferably, the gas-generating additive is solid powder preparation, liquid preparation, or gel preparation, and the water-generating additive is solid powder preparation, liquid preparation, or gel preparation.

Preferably, the gas-generating additive and the water-generating additive are separately placed in at least one of: the case, the electrodes, the separator, or the electrolyte.

Preferably, when the secondary battery is a hard-case battery, the secondary battery further includes a support frame and a insulative film, and a position of the case of the secondary battery includes an interior of the cell, a position between the cell and the insulative film, a position between the insulative film and the case, and a position on the support frame; and when the secondary battery is a soft-package battery, the position of the case of the secondary battery includes an interior of the cell and a position between the cell and the case.

Preferably, when the gas-generating additive is placed in the electrodes, the gas-generating additive is dispersed in the active material layer or coated on a surface of the electrodes, the active material layer also comprises an active material, preferably, when the gas-generating additive is dispersed in the active material layer, the gas-generating additive is 0.5%-10% by weight of the active material.

Preferably, the weight of water-generating additive is 0.01 g-200 g, the weight of gas-generating additive is 1 g-100 g.

The technical solutions of the present application at least have the following beneficial effects:

The secondary battery of the present application includes the gas-generating additive and the water-generating additive, the gas-generating additive is compound capable of decomposing under high voltage; and the water-generating additive is compound generating water at high temperature. During the overcharging process of the Li-ion battery, when the battery reaches a certain temperature, the water-generating additive decomposes and generates a large amount of water. Then, the water can provide free radical such as H and induce Li salt and the gas-generating additive to decompose and generate a large amount of gas, so that when the internal pressure of the battery reaches a certain value, the charging current is interrupted in advance by a device for interrupting charging current. The device is placed in the secondary battery and utilizes air flow to interrupt the charging current, for example, a current interrupt device is interrupted or a safety short device deforms. The water generated at the same time can absorb heat generated by the battery, and the internal temperature of the battery decreases, thereby preventing the overcharge failure of the battery.

Thermal runaway caused by heat accumulation is prevented in the secondary battery of the present application. Additionally, the secondary battery has advantages of easy selection of materials, controllable temperature, and high reliability.

The present application will be illustrated in further detail with reference to specific embodiments. It should be understood that, the embodiments are only used to explain the present application, rather than limit the scope of the present application.

### DESCRIPTION OF EMBODIMENTS

In our study of the overcharging process, it is found that there are two solutions to prevent the battery from being overcharged. One solution is to interrupt the charging current before the battery suffers thermal runaway by taking advantage of increasing of internal pressure of the battery during the overcharging process. Generally speaking, for a hard-case battery, a device for interrupting charging current includes current interrupt device (Current Interrupt Device, CID), safety short device (Safety Short Device, SSD), and so on. However, before the overcharge failure of the battery, little gas is generated, thus, a gas-generating additive is added for generating more gas during the overcharging process. If the amount of the gas-generating additive is too little, the generated gas is not enough. If the amount of the gas-generating additive is too much, it may affect the electrical property under normal usage conditions (e.g., 25° C. 100% SOC storage, DCR). The other solution is to use the heat generated during the overcharging process. Before the overcharge failure, the internal temperature of the battery is between 60° C.-150° C., and most electrolyte will not decompose, such that the generated gas is not enough. In the Li-ion battery, a principle of gas generation by reactions of water, electrolyte, and the gas-generating additive is illustrated as follows (high temperature and high voltage can accelerate the reactions as follows):

H₂O+LiPF₆→POF₃+PO₂F+H₃PO₄+HF (1)

H2O+(CH₂OCO₂Li)₂→Li₂CO₃+CO↑ (2)

2HF+Li₂CO₃=2LiF+H₂O↑+CO₂↑ (3)

A technical solution of the present application skillfully utilizes advantages of the above-mentioned solutions, in which both the gas-generating additive and a water-generating additive are added into the secondary battery at the same time. The gas-generating additive includes at least one compound capable of decomposing under high voltage. The water-generating additive includes at least one of an inorganic compound or an organic compound, and the inorganic compound and the organic compound are capable of decomposing and generating water when being heated. During the overcharging process of the Li-ion battery, when the battery reaches a certain temperature, the water-generating additive decomposes and generates water. Then, the generated water can provide free radical such as H, which can induce Li salt and the gas-generating additive to decompose, thereby generating a large amount of gas. As a result, when the internal pressure of the battery reaches a certain threshold, the charging current is interrupted in advance by a stop-charging device. The device utilizes the air flow to interrupt charging by the external power supply.

Moreover, the water generated can absorb heat generated by the battery, and thus decreases the internal temperature of the battery, thereby preventing the overcharge failure of the battery.

The stop-charging device preferably includes a CID or a SSD. When the internal pressure increases, the current interrupt device is interrupted, or the SSD deforms.

The SSD allows a short circuit between negative electrode and positive electrode by air pressure, so that the fuse is fused, resulting in that the positive electrode terminal is disconnected from the cell. The CID allows an open circuit between the negative electrode and positive electrode by air pressure, such that it is difficult to continue charging the battery.

For a soft-package battery, the power supply can be interrupted directly in a manner of breaking an aluminum-plastic package film of the soft-package battery by expanding.

In an exemplary embodiment of the present application, the gas-generating additive includes at least one of a group consisting compounds capable of decomposing under high voltage, preferably, the gas-generating additive includes lithium carbonate.

In an exemplary embodiment of the present application, the water-generating additive includes at least one of a group consisting of inorganic compounds or organic compounds capable of decomposing and generating water when being heated.

Preferably, the inorganic compound includes at least one of a group consisting of hydroxide, acidic salt, basic salt, and hydrate.

Preferably, the hydroxide includes at least one of a group consisting of zinc hydroxide, aluminum hydroxide, magnesium hydroxide, and copper hydroxide.

Preferably, the acidic salt includes at least one of a group consisting of ammonium oxalate and sodium bicarbonate.

Preferably, the basic salt includes at least one of a group consisting of basic cupric carbonate and basic magnesium carbonate.

Preferably, the hydrate includes at least one of a group consisting of manganese acetate tetrahydrate, aluminium chloride hexahydrate, copper sulfate pentahydrate, and aluminum potassium sulfate dodecahydrate.

Preferably, the organic compound is selected from compounds containing at least one carboxyl, and preferably, includes alkyl containing at least one carboxyl, such as alkane containing at least one carboxyl, alkene containing at least one carboxyl, and benzene containing at least one carboxyl. More preferably, the organic compound is oxalic acid.

In an exemplary embodiment of the present application, and a decomposing temperature of the water-generating additive is between 60° C.-150° C.

In an exemplary embodiment of the present application, the gas-generating additive can be solid powder preparation, liquid preparation, or gel preparation, and the water-generating additive can be solid powder preparation, liquid preparation, or gel preparation.

In an exemplary embodiment of the present application, the water-generating additive further includes other additives, such as adhesive or solvent, which can be selected by person skilled in the art according to specific needs. According to specific needs, the water-generating additive can be made as solid preparation, liquid preparation, or gel preparation.

In an exemplary embodiment of the present application, the gas-generating additive further includes other additives, and can be made as solid powder preparation, liquid preparation, or gel preparation.

In an exemplary embodiment of the present application, the gas-generating additive and the water-generating additive are separately placed in a case of the secondary battery, in electrodes of the secondary battery, on a separator of the secondary battery, or in the electrolyte of the secondary battery.

In an exemplary embodiment of the present application, when the gas-generating additive is placed in the electrodes, the gas-generating additive is dispersed in the electrodes, coated on a surface of the electrodes, or coated on a current collector of the secondary battery. That is to say, in the process of manufacturing the electrodes, the gas-generating additive is mixed with materials of the positive electrode or the negative electrode, so that a positive film plate containing the gas-generating additive or a negative film plate containing the gas-generating additive is prepared. When the gas-generating additive is lithium carbonate, preferably, the gas-generating additive is placed in the positive electrode. In an exemplary embodiment of the present application, the gas-generating additive can be made into slurry, and then coated on the electrodes.

When coating, a coating thickness of the gas-generating additive is 1 μm-10 μm.

In an exemplary embodiment of the present application, the gas-generating additive and the water-generating additive are separately placed, and can be placed in the same position of the secondary battery or placed in different positions of the secondary battery.

In an exemplary embodiment of the secondary battery of the present application, the secondary battery is a hard-case battery, the secondary battery further includes a support frame and an insulative film, and internal position of a case of the secondary battery includes an interior of a cell of the secondary battery, a position between the cell and the insulative film, a position between the insulative film and the case, and a position on the support frame.

When the secondary battery is a soft-package battery, the case is an aluminum-plastic film packaging a cell, and internal position of the case of the secondary battery includes an interior of the cell, a position between the cell and the aluminum-plastic film.

Preferably, the water-generating additive is placed in the case of the secondary battery, and maximally contacts a heating surface of the cell.

Preferably, the water-generating additive is placed in the interior of the cell, and more specifically, is placed between two cells.

In an exemplary embodiment of the secondary battery of the present application, the gas-generating additive and the water-generating additive are placed in an accommodation device, and the accommodation device accommodating the gas-generating additive and the water-generating additive is placed in the secondary battery. The accommodation device can be made of plastic film, such as polyethylene (PE) and polypropylene (PP). Additionally, the accommodation device has a function of fixing the gas-generating additive or the water-generating additive in the accommodation device.

In an exemplary embodiment of the secondary battery of the present application, the accommodation device is sealed or not sealed.

Specifically, the gas-generating additive or the water-generating additive can be fixed in the accommodation device by coating, adhesive bonding, or embedding.

Specifically, the gas-generating additive or the water-generating additive can be made into slurry and then coated in the interior of the accommodation device to form a coating layer, or can be adsorbed by a porous material and then fixed in the accommodation device, or can be directly adhered in the accommodation device by an adhesive.

When the accommodation device adopts a sealing structure, by a decompressing package manner, the accommodation device is vacuumed and then sealed, so as to keep the package in a highly decompressed state, so that the gas-generating additive or the water-generating additive is fixed. If the water-generating additive is placed in the sealed accommodation device, at a certain temperature and pressure, the accommodation device is broken and releases water vapor. A sealing strength of the accommodation device can be adjusted by material of the sealing structure or by sealing strength of the sealing structure, for example, the material of the sealing structure can be packaging material with a low softening temperature (such as polyethylene), or the sealing structure includes a weak point with low sealing strength.

In an exemplary embodiment of the secondary battery of the present application, the secondary battery includes 0.01 g-200 g of the water-generating additive. If the amount of water-generating additive is too little, heat adsorbing function is poor. If the amount of water-generating additive is too much, mass of the secondary battery is increased, and the water-generating additive occupies too much space of the secondary battery, thereby decreasing energy density of the secondary battery.

The gas-generating additive is 1 g-100 g.

In an exemplary embodiment of the secondary battery of the present application, the gas-generating additive is placed in the electrodes, and the gas-generating additive is dispersed in an active material layer or coated on a surface of the electrodes, the active material layer also comprises an active material, preferably, when the gas-generating additive is dispersed in the active material layer, the gas-generating additive is 0.5%-10% by weight of the active material.

It should be understood that, the above general description and a detailed description as follows are merely for the purpose of illustration and are not intended to limit the present application.

Experiments are conducted on the secondary battery provided by the present application as below.

### Embodiment 1

A square hard-case battery is used in a power battery, with a working voltage range of 2.8V-4.2V. A battery capacity of the square hard-case battery is listed in Table 1. A top cover of the square hard-case battery includes a stop-charging device which utilize air flow, and a safety device such as SSD, anti-explosion valve, and the like.

### Comparative Example: Only Including the Gas-Generating Additive

### Experimental Example: Including Both the Gas-Generating Additive and the Water-Generating Additive

Placement of the gas-generating additive: lithium carbonate and a cathode active material are mixed and made into slurry, and then coated on the current collector, so as to form the positive electrode. The gas-generating additive is 2.5% by weight of the cathode active material.

Placement of the Water-Generating Additive:

Coated on the separator: the water-generating additive is made into slurry, and coated on the separator, and then the separator is assembled to the battery.

Coated on the electrodes: the water-generating additive is made into slurry, and coated on the electrode, and then the electrode is assembled to the battery.

Dispersed in the electrode: the water-generating additive and the active material are mixed and made into slurry, then coated on the current collector, and then the current collector is assembled to the battery.

Placed in the case: the water-generating additive is grinded, packaged by a PE film, placed in the case, and then the case is assembled to the battery.

Placed between the cell and the insulative film: the water-generating additive is grinded, packaged by a PE film, and then placed between the cell and the insulative film.

The overcharging process: under 100% stage of charging (SOC), the square hard-case battery is charged with 1C to 200% or 2Vmax.

Results tested are listed in Table 2.

TABLE 1

| | | Stop-charging | | | |
|---|---|---|---|---|---|
| | Battery | device utilizing | Water-generating additive | | |
| No. | capacity | air flow | Composition | Position | Content |
| Hard-case | 100 Ah | SSD | Zn(OH)₂ | Coated on the | 40 g |
| battery 1 | | | | separator | |
| Hard-case | 50 Ah | CID | NaHCO₃ | Coated on the | 20 g |
| battery 2 | | | | electrodes | |
| Hard-case | 6 Ah | CID | H₂C₂O₄ | Placed in the cell | 5 g |
| battery 3 | | | | | |
| Hard-case | 28 Ah | CID | CuSO₄•5H₂O | Placed between the | 10 g |
| battery 4 | | | | cell and the | |
| | | | | insulative film | |
| Hard-case | 50 Ah | SSD | AlCl₃•6H₂O | Dispersed in anode | 20 g |
| battery 5 | | | | electrode film | |
| Hard-case | 28 Ah | CID | C₄H₆O₄Ni•4H₂O | Placed between the | 10 g |
| battery 6 | | | | insulative film and | |
| | | | | the case | |
| Hard-case | 50 Ah | SSD | KAl(SO₄)₂•12H₂O | Placed on the | 20 g |
| battery 7 | | | | support frame | |
| Hard-case | 6 Ah | CID | AlCl₃•6H₂O | Placed in the cell | 3 g |
| battery 8 | | | | | |
| Hard-case | 50 Ah | CID | H₂C₂O₄ | Placed in the | 20 g |
| battery 9 | | | | electrolyte | |
| Comparative | 100 Ah | SSD | — | — | — |
| example 1 | | | | | |

TABLE 2

| No. | Phenomenon 1 | Phenomenon 2 |
|---|---|---|
| Hard-case | When the battery is overcharged for 0.6 h (160% SOC), the | The anti-explosion valve |
| battery 1 | temperature of the battery is 60° C., SSD deforms, and a | is not opened, no |
| | voltage of the battery is 0. Subsequently, the temperature | thermal runaway |
| | quickly decreases to 57° C., then the temperature increases to | occurred. |
| | 65° C. due to self-heat generation, and until the test is | |
| | finished, failure of the battery has not occurred. | |
| Hard-case | Under 110% SOC, the temperature of the battery decreases; | The anti-explosion valve |
| battery 2 | and under 140% SOC, SSD deforms, and the temperature of | is not opened, no |
| | the battery increases and then decreases. | thermal runaway |
| | | occurred. |
| Hard-case | Under 160% SOC, SSD deforms, and the temperature of the | The anti-explosion valve |
| battery 3 | battery decreases, | is not opened, no |
| | | thermal runaway |
| | | occurred. |
| Hard-case | Under 110% SOC, the temperature of the battery decreases; | The anti-explosion valve |
| battery 4 | and under 150% SOC, SSD deforms, and the temperature of | is not opened, no |
| | the battery increases and then decreases. | thermal runaway |
| | | occurred. |
| Hard-case | Under 120% SOC, the temperature of the battery decreases; | The anti-explosion valve |
| battery 5 | and under 150% SOC, SSD deforms, and the temperature of | is not opened, no |
| | the battery increases and then decreases. | thermal runaway |
| | | occurred. |
| Hard-case | Under 130% SOC, the temperature of the battery decreases; | The anti-explosion valve |
| battery 6 | and under 150% SOC, SSD deforms, and the temperature of | is not opened, no |
| | the battery increases and then decreases. | thermal runaway |
| | | occurred. |
| Hard-case | Under 110% SOC, the temperature of the battery decreases; | The anti-explosion valve |
| battery 7 | and under 150% SOC, SSD deforms, and the temperature of | is not opened, no |
| | the battery increases and then decreases. | thermal runaway |
| | | occurred. |
| Hard-case | When the battery is overcharged for 0.2 h (120% SOC), the | The anti-explosion valve |
| battery 8 | temperature of the battery decreases and then increases until | is not opened, no |
| | 150% SOC, SSD deforms, and a voltage of the battery is 0. | thermal runaway |
| | Subsequently, the temperature of the battery slowly | occurred. |
| | increases to 70° C., and until the test is finished, failure of the | |
| | battery has not occurred. | |
| Hard-case | When the battery is overcharged to 0.3 h (130% SOC), the | The anti-explosion valve |
| battery 9 | temperature of the battery is 60° C., the temperature of the | is not opened, no |
| | battery decreases and then increases until 160% SOC, SSD | thermal runaway |
| | deforms, and a voltage of the battery becomes 0. | occurred. |
| | Subsequently, the temperature of the battery quickly | |
| | decreases to 70° C., and until the test is finished, failure of | |
| | the battery has not occurred. | |
| Comparative | When the battery is overcharged for 0.7 h (170% SOC), the | The anti-explosion valve |
| example 1 | temperature of the battery is 80° C., and the temperature of | is opened, thermal |
| | the battery quickly increases to above 300° C. due to | runaway occurred. |
| | self-heat generation, and then the battery is burning. | |

### Embodiment 2

A soft-package battery is used in Li-ion battery of consuming electronic products, with a working voltage range of 3.0V-4.35V. A battery capacity of the soft package battery is listed in Table 3.

### Comparative Example: Only Including the Gas-Generating Additive

### Experimental Example: Including Both the Gas-Generating Additive and the Water-Generating Additive

Placement of the gas-generating additive: lithium carbonate and a cathode active material are mixed and made into slurry, and then coated on the current collector, so as to form the positive electrode including the gas-generating additive. The weight of the gas-generating additive is 2.5% of the weight of the cathode active material.

Placement of the Water-Generating Additive:

Coated on the separator: the water-generating additive is made into slurry, and coated on the separator, and then the separator is assembled to the battery.

Coated on the electrode: the water-generating additive is made into slurry, and coated on the electrode, and then assemble the battery.

Dispersed in the active material layer: the water-generating additive and the active material are mixed and made into slurry, then coated on the current collector, and then assemble the battery.

Placed in an aluminum-plastic film: the water-generating additive is grinded, packaged by a PE film, and placed between the cell and the aluminum-plastic film, and then assemble the battery.

The overcharging process: under 100% SOC, the soft-package battery is charged with 1C to 200% SOC or 2Vmax.

Results tested are listed in Table 4.

TABLE 3

| | Battery | Water-generating additive | | |
|---|---|---|---|---|
| No. | capacity | Composition | Position | Content |
| Soft package | 6 Ah | Zn(OH)₂ | Coated on the | 5 g |
| battery 1 | | | separator. | |
| Soft package | 50 Ah | NaHCO₃ | Coated on the | 20 g |
| battery 2 | | | electrode. | |
| Soft package | 31 Ah | KAl(SO4)₂•12H₂O | Placed in the | 15 g |
| battery 3 | | | cell. | |
| Soft package | 31 Ah | AlCl₃•6H₂O | Placed between | 15 g |
| battery 4 | | | the cell and the | |
| | | | aluminum-plastic | |
| | | | film. | |
| Comparative | 31 Ah | — | — | — |
| example 2 | | | | |

TABLE 4

| No. | Phenomenon 1 | Phenomenon 2 |
|---|---|---|
| Soft package | When the battery is overcharged to 160% SOC, the pocket is | No thermal |
| battery 1 | broken, a large amount of remaining electrolyte and a large | runaway |
| | amount of heat is released, resistance of the battery increases and | |
| | voltage of the battery decreases to 0. | |
| Soft package | When the battery is overcharged to 140% SOC, the pocket is | No thermal |
| battery 2 | broken, a large amount of remaining electrolyte and a large | runaway |
| | amount of heat is released, resistance of the battery increases and | |
| | voltage of the battery decreases to 0. | |
| Soft package | When the battery is overcharged to 160% SOC, the pocket is | No thermal |
| battery 3 | broken, a large amount of remaining electrolyte and a large | runaway |
| | amount of heat is released, resistance of the battery increases and | |
| | voltage of the battery decreases to 0. | |
| Soft package | When the battery is overcharged to 165% SOC, the pocket is | No thermal |
| battery 4 | broken, a large amount of remaining electrolyte and a large | runaway |
| | amount of heat is released, resistance of the battery increases and | |
| | voltage of the battery decreases to 0. | |
| Comparative | When the battery is overcharged to 180% SOC, the pocket is | Thermal runaway |
| example | broken, a large amount of remaining electrolyte and a large | |
| | amount of heat is released, resistance of the battery increases and | |
| | voltage of the battery decreases to 0. | |

The embodiments described above are merely preferred embodiments of the present application and they do not limit the present application. Any modification, equivalent replacement, and improvement made within the spirit and principle of the present application shall fall within the scope of the present application. Therefore, the protection scope of the present application shall be defined by the claims of the present application.

What is claimed is:

1. A secondary battery, comprising: a cell, an electrolyte and a case, the cell comprising electrodes and a separator; wherein the secondary battery further comprises a gas-generating additive and a water-generating additive.

2. The secondary battery according to claim 1, wherein the secondary battery further comprises a device for interrupting charging current, the device is preferably a current interrupt device or a safety short device.

3. The secondary battery according to claim 1, wherein the gas-generating additive comprises at least one of a group consisting of compounds capable of decomposing under high voltage, preferably, the gas-generating additive is lithium carbonate.

4. The secondary battery according to claim 1, wherein the water-generating additive comprises at least one of an inorganic compound and an organic compound which decompose and generate water when being heated; preferably, the inorganic compound is selected from a group consisting of hydroxide, acidic salt, basic salt, hydrate and combinations thereof; the hydroxide is preferably selected from a group consisting of zinc hydroxide, aluminum hydroxide, magnesium hydroxide, copper hydroxide and combinations thereof; the acidic salt is preferably selected from a group consisting of ammonium oxalate, sodium bicarbonate and combinations thereof; the basic salt is preferably selected from a group consisting of basic cupric carbonate, basic magnesium carbonate and combinations thereof; the hydrate is preferably selected from a group consisting of manganese acetate tetrahydrate, aluminium chloride hexahydrate, copper sulfate pentahydrate, aluminum potassium sulfate dodecahydrate and combinations thereof; and the organic compound is a compound containing at least one carboxyl, preferably, the organic compound is oxalic acid.

5. The secondary battery according to claim 1, wherein a decomposing temperature of the water-generating additive is between 60° C.-150° C.

6. The secondary battery according to claim 1, wherein the gas-generating additive is solid powder preparation, liquid preparation or gel preparation, and the water-generating additive is solid powder preparation, liquid preparation or gel preparation.

7. The secondary battery according to claim 1, wherein the gas-generating additive and the water-generating additive are separately placed in at least one of: the case, the electrodes, the separator, or the electrolyte.

8. The secondary battery according to claim 7, wherein when the secondary battery is a hard-case battery, the secondary battery further comprises a support frame and an insulative film, and a position of the case of the secondary battery comprises an interior of the cell, a position between the cell and the insulative film, a position between the insulative film and the case, and a position on the support frame; and when the secondary battery is a soft-package battery, the position of the case of the secondary battery comprises an interior of the cell and a position between the cell and the case.

9. The secondary battery according to claim 1, wherein when the gas-generating additive is placed in the electrodes, the gas-generating additive is dispersed in an active material layer or coated on a surface of the electrodes, the active material layer also comprises an active material, preferably, when the gas-generating additive is dispersed in the active material layer, the gas-generating additive is 0.5%-10% by weight of the active material.

10. The secondary battery according to claim 1, wherein the weight of water-generating additive is 0.01 g-200 g, the weight of gas-generating additive is 1 g-100 g.
